(19) United States
(12) Patent Application Publication
(10) Pub. No.: US 2018/0300937 A1
(43) Pub. Date: Oct. 18, 2018

(54) SYSTEM AND A METHOD OF RESTORING AN OCCLUDED BACKGROUND REGION

(71) Applicants: National Taiwan University, Taipei (TW); Himax Technologies Limited, Taipei City (TW)

(72) Inventors: Shao-Yi Chien, Taipei (TW); Yung-Lin Huang, Taipei (TW); Po-Jen Lai, Taipei (TW); Yi-Nung Liu, Tainan City (TW)

(21) Appl. No.: 15/487,331

(22) Filed: Apr. 13, 2017

(51) Int. Cl. G06T 15/04; G06T 7/194

(52) U.S. Cl. CPC G06T 15/04; G06T 7/194

(57) ABSTRACT

A system and method of restoring an occluded background region includes detecting surfaces of a point cloud, thereby resulting in a surface map; substantially enhancing edges between detected surfaces according to a gradient map and the surface map, thereby generating an edge map; inpainting a depth image, thereby generating in an inpainted depth image; and inpainting a color image, thereby generating an inpainted color image.

### BACKGROUND OF THE INVENTION

### 1. Field of the Invention

The present invention generally relates to a system and method of restoring an occluded background region, and more particularly to surface-based background completion in 3D scene.

### 2. Description of Related Art

Visualization of the 3D point cloud Model has played a crucial part in augmented reality (AR) and virtual reality (VR) for a long time. The 3D point cloud models have been widely available because of the current RGB and depth (RGB-D) cameras. As light cannot penetrate opaque objects, shadows would appear behind foreground objects in the scene. These shadows leave missing points in the background structure. The missing data can be retrieved by taking photos from multiple viewpoints. However, sometimes a set of multi-view photos is hard to get because the space is limited or the camera is static. Therefore, a need has arisen to propose a scheme to restore background regions that are occluded by foreground objects.

In the research on the point cloud model visualization, image inpainting plays a key role. Image inpainting or image completion is the problem of filling plausible colors into a specified region of an image. For an image, we specify a foreground region where we would like to determine plausible colors behind it. We hope that the background appears to be continuous with neighboring area. By filling the occluded background region or hole, the 3D point cloud model can be viewed from positions other than the original one, introducing an improving effect and experience of visualization.

### SUMMARY OF THE INVENTION

In view of the foregoing, it is an object of the embodiment of the present invention to provide surface-based background completion in 3D scene that is capable of successfully filling holes with realistic color and structure.

Summarily speaking, we adopt the idea of exemplar-based inpainting and the surface detection method. We first detect the plane in the 3D point cloud model to help recover the depth map of the scene and reconstruct the geometric structure behind our target object. Further, we decide the colors of the hole on background which is resulted from the removal of the foreground object. At last, we rebuild the scene according to the inpainted RGB and depth images to achieve a more well-rounded visualization.

According to one embodiment, a system of restoring an occluded background region includes a surface detection unit, an edge detection unit, a depth inpainting unit and a color inpainting unit. The surface detection unit detects surfaces of a point cloud, thereby resulting in a surface map. The edge detection unit substantially enhances edges between detected surfaces according to a gradient map and the surface map, thereby generating an edge map. The depth inpainting unit inpaints a depth image, thereby generating in an inpainted depth image. The color inpainting unit inpaints a color image, thereby generating an inpainted color image.

### BRIEF DESCRIPTION OF THE DRAWINGS

FIG. 1 shows a block diagram illustrating a system of restoring an occluded background region according to one embodiment of the present invention;

FIG. 2 shows a flow diagram illustrating a method of restoring an occluded background region according to one embodiment of the present invention;

FIG. 3 exemplifies generating an edge map according to a gradient map and a surface map; and

FIG. 4A and FIG. 4B respectively show original image and inpainted image based on exemplary-based inpainting.

### DETAILED DESCRIPTION OF THE INVENTION

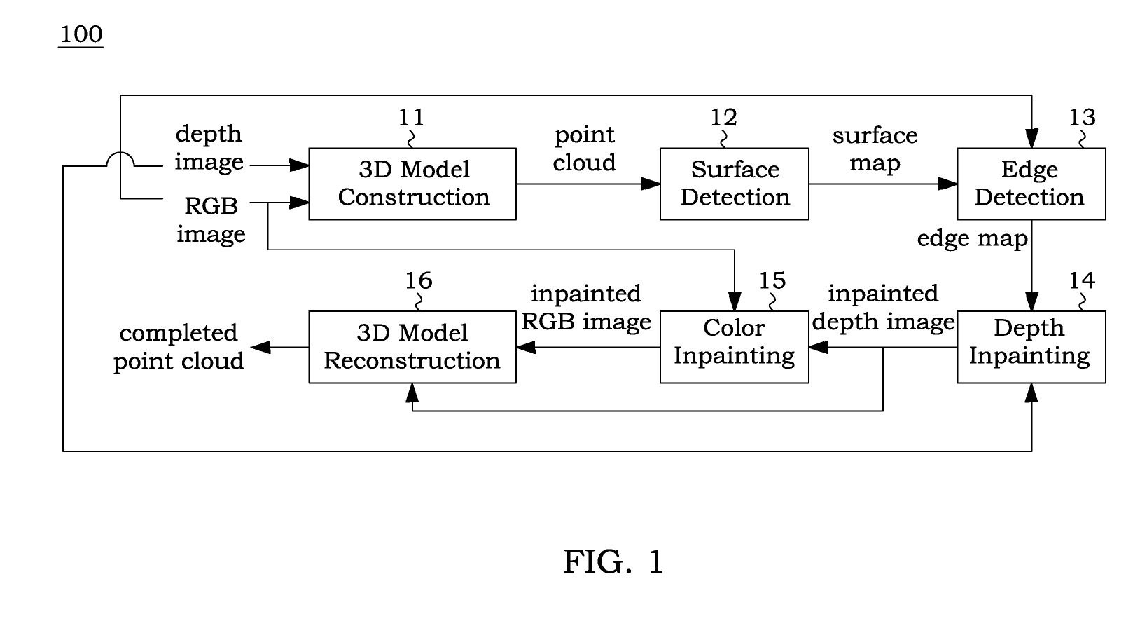

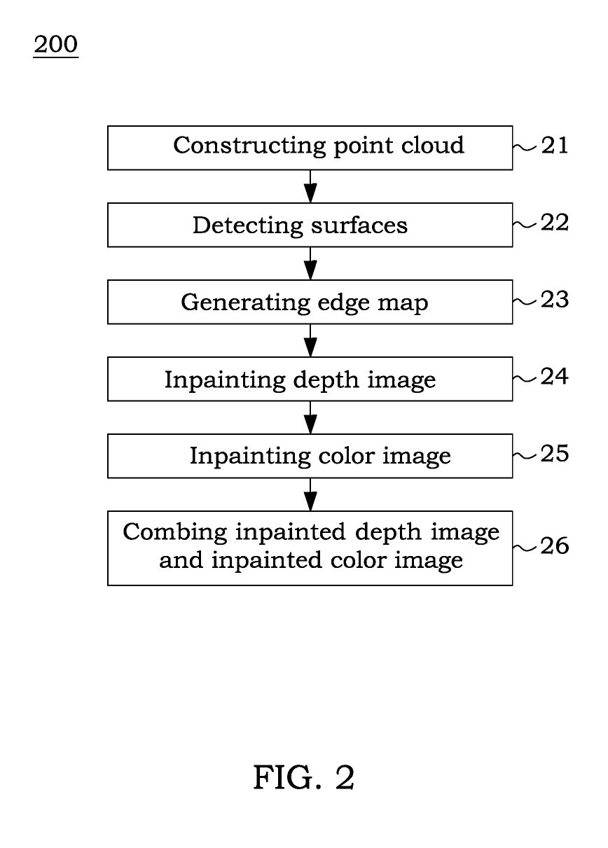

FIG. 1 shows a block diagram illustrating a system 100 of restoring an occluded background region according to one embodiment of the present invention, and FIG. 2 shows a flow diagram illustrating a method 200 of restoring an occluded background region according to one embodiment of the present invention. The system 100 and/or the method 200 may, but not necessarily, be adaptable to augmented reality (AR) and virtual reality (VR). The system 100 and the method 200 may be implemented by hardware, software or their combination. To be more specific, blocks of FIG. 1 and steps of FIG. 2 of one embodiment may be performed, for example, by an electronic circuit such as a digital image processor. Alternatively, blocks of FIG. 1 and steps of FIG. 2 of another embodiment may be performed, for example, by a computer caused by program instructions contained in a non-transitory computer readable medium.

In step 21, a three-dimensional (3D) point cloud model (abbreviated as point cloud hereinafter) is constructed by a 3D model construction unit 11. In the specification, a point cloud is a set of data points in a three-dimensional coordinate system, where the data points are defined, for example, by X, Y, and Z coordinates. The data points of the point cloud may, for example, represent the external surface of an object.

Specifically, in the embodiment, the point cloud is constructed according to a color image such as a RGB (i.e., color red, color green and color blue) image and a depth image, which may be captured by a conventional 3D scanning device or camera such as a RGB and depth camera (usually abbreviated as RGB-D camera). In the embodiment, the term “image” is interchangeable with a still or static image. The point cloud of the embodiment is a single-view point cloud. As a result, background areas may be occluded by foreground objects, and it is one of objects of the embodiment to restore the occluded background regions (also called as holes) and complete (or inpaint) the background behind the foreground objects.

In step 22, surfaces of the point cloud are detected by a surface detection unit 12, resulting in a surface map (image) representing surfaces of objects with their outlines, thereby revealing the relationship between the surfaces and therefore obtaining plane information of the point cloud. In the embodiment, curved surfaces as well as planar surfaces in the point cloud are detected. Specifically, in the embodiment, a down-sampled graph is first generated by supervoxel segmentation. Subsequently, a recursive bottom-up agglomerative hierarchical clustering approach is adopted to merge the supervoxels into surfaces. At last, refinements on noisy and occluded planes are performed to correct the trend of oversegmentations. Details of surface detection may be referred to “Efficient Surface Detection for Augmented Reality on 3D Point Clouds,” entitled to Y. C. Kung et al., Computer Graphics International (CGI), 2016, the disclosure of which is incorporated herein by reference.

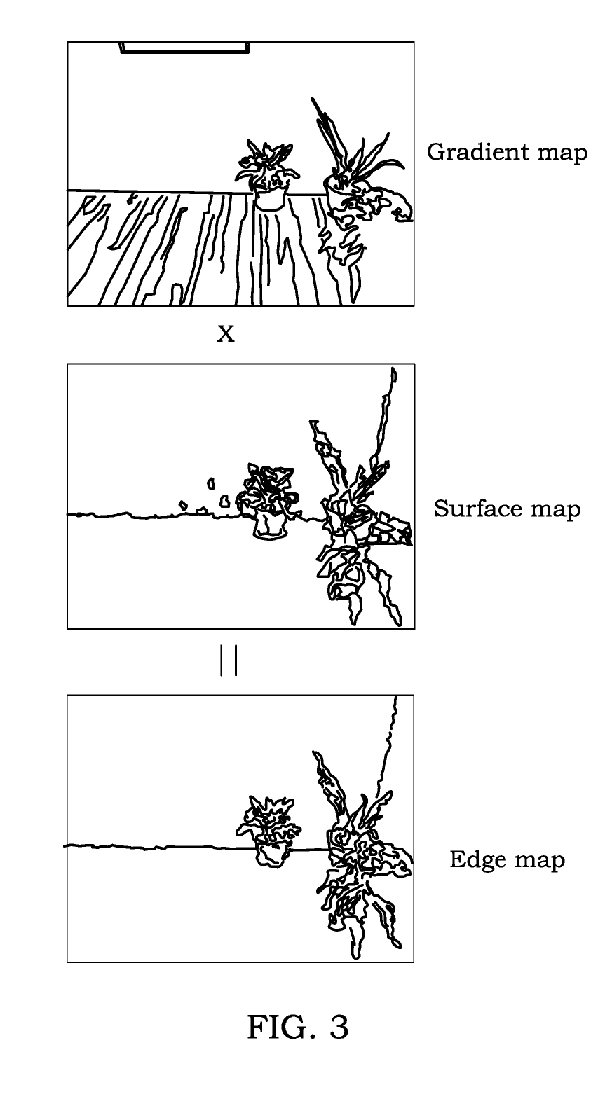

Although planar and curved surface information are obtained in step 22, it still cannot achieve a perfect segmentation. To solve this problem, the flow of the method 200 then goes to step 23 to generate an edge map (image) by an edge detection unit 13. This step performs an edge-preserving texture suppression on the surface map, thereby discarding textures of 3D surfaces and substantially enhancing (or restoring) the edges between different surfaces. Specifically, in the embodiment, a gradient map (image) representing directional change in intensity or color in an image is first obtained according to the RGB image. Subsequently, according to one aspect of the embodiment, an edge map with substantially preserved edge but suppressed texture is generated according to the gradient map and the surface map. In the embodiment, the edge map is generated by performing conjunction (i.e., AND) operation on the gradient map and the surface map. In other words, a pixel in the edge map has a value “1” only if corresponding pixels in both the gradient map and the surface map have the value “1”. FIG. 3 exemplifies generating an edge map according to a gradient map and a surface map.

Afterwards, in step 24, a depth inpainting unit 14 inpaints portions around a boundary of the detected surfaces in the depth image based on the edge map, thereby resulting in a an inpainted depth image. In the specification, the term inpainting, as usually used in the image processing field, refers to a process of reconstructing parts of an image. Generally speaking, while inpainting the depth image, the occluded background region is first removed or masked, and then the pixels in the masked region are constructed or estimated, for example, by using interpolating technique.

In the embodiment, the holes in the depth image may be inpainted using exemplary-based algorithm such as one disclosed in “Region filling and object removal by exemplar-based image inpainting,” entitled to A. Criminisi et al, IEEE Transactions on image processing, 13(9), 1200-1212, 2004, the disclosure of which is incorporated herein by reference.

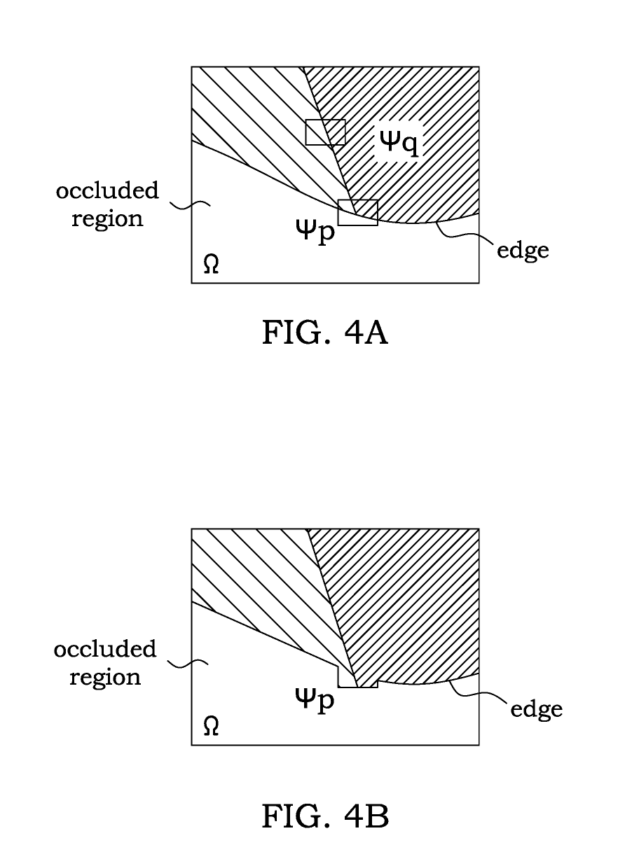

In the embodiment, a searching region restricted to a window around a target, instead of entire region, in the depth image is filled (or inpainted). Accordingly, a patch size may be enlarged to avoid a time-consuming patch search. FIG. 4A and FIG. 4B respectively show original image and inpainted image based on exemplary-based inpainting. The searching region to be filled is denoted by Ω. The target patch Ψₚ and the candidate source patch Ψ_{q} are as shown. We search for a patch in the source region with the minimum score according to the distance function d(Ψ_{q}, Ψₚ), which is computed as the sum of squared differences vectors between source patch and target patch. After the source patch Ψ_{q} is copied into the target patch Ψₚ, the linear structure (i.e., the boundary between two surfaces) may be continued appropriately into the occluded region.

In step 25, the color image, such as RGB image, is inpainted by a color inpainting unit 15 based on the inpainted depth image, thereby generating an inpainted color image. Generally speaking, while inpainting the color image, the occluded background region is first removed or masked, and then the pixels in the masked region are constructed or estimated, for example, by using interpolating technique. In the embodiment, the holes in the color image may be inpainted, for example, using aforementioned exemplary-based algorithm disclosed by A. Criminisi et al.

As human eyes are quite sensitive to drastic color and structural change in an image, in the embodiment, the depth image is inpainted (in step 24) before inpainting the color image (in step 25), such that we can thus prominently lower the effect of artifacts perceived by people. In another embodiment, nevertheless, the color image may be inpainted before the depth image.

In step 26, the inpainted depth image (from step 24) and the inpainted color image (from step 25) are combined by a 3D model reconstruction unit 16, thereby resulting in a completed point cloud with added information of the occluded background region.

According to the embodiment discussed above, we propose a flow that is capable of successfully filling holes with realistic color and structure. We operate the dataset in the gradient domain and then reconstruct depth to ensure a convincing 3D structure. After the depth inpainting work (step 24) is done, we can further inpaint the colors of the background (step 25) by more sufficient information to produce a more gratifying result. The results indicate that the recovery of the indoor scene is quite realistic and our method performs fewer artifacts and holes than others. Also, our method can plausibly fill holes, making the data easily viewable from multiple viewpoints without perceptual artifacts to achieving a greater visualization. All of the inpainting work is conducted in the 2D domain rather than directly in 3D. The embodiment can be applied to rebuilding the background regions of indoor models, which will be helpful in AR and VR development.

Although specific embodiments have been illustrated and described, it will be appreciated by those skilled in the art that various modifications may be made without departing from the scope of the present invention, which is intended to be limited solely by the appended claims.

What is claimed is:

1. A system of restoring an occluded background region, comprising:
a surface detection unit that detects surfaces of a point cloud, thereby resulting in a surface map;
an edge detection unit that substantially enhances edges between detected surfaces according to a gradient map and the surface map, thereby generating an edge map;
a depth inpainting unit that inpaints a depth image, thereby generating in an inpainted depth image; and
a color inpainting unit that inpaints a color image, thereby generating an inpainted color image.

2. The system of claim 1, further comprising a 3D model construction unit that constructs the point cloud according to the color image and the depth image.

3. The system of claim 2, further comprising a 3D camera that captures the color image and the depth image.

4. The system of claim 1, wherein the point cloud comprises a single-view point cloud.

5. The system of claim 1, wherein the surfaces comprise planar surfaces and curved surfaces.

6. The system of claim 1, wherein the edge map is generated by performing AND operation on the gradient map and the surface map.

7. The system of claim 1, wherein the depth inpainting unit inpaints the depth image based on the edge map.

8. The system of claim 7, wherein the depth inpainting unit performs the following steps:
masking the occluded background region; and
constructing pixels in the masked region by interpolating technique.

9. The system of claim 1, wherein the depth inpainting unit inpaints the depth image using exemplary-based algorithm.

10. The system of claim 1, wherein the color inpainting unit inpaints the color image based on the inpainted depth image.

11. The system of claim 10, wherein the color inpainting unit performs the following steps:
masking the occluded background region; and
constructing pixels in the masked region by interpolating technique.

12. The system of claim 1, wherein the color inpainting unit inpaints the color image using exemplary-based algorithm.

13. The system of claim 1, further comprising a 3D model reconstruction unit that combines the inpainted depth image and the inpainted color image, thereby resulting in a completed point cloud.

14. A method of restoring an occluded background region, comprising:
detecting surfaces of a point cloud, thereby resulting in a surface map;
substantially enhancing edges between detected surfaces according to a gradient map and the surface map, thereby generating an edge map;
inpainting a depth image, thereby generating in an inpainted depth image; and
inpainting a color image, thereby generating an inpainted color image.

15. The method of claim 14, further comprising a step of constructing the point cloud according to the color image and the depth image.

16. The method of claim 14, wherein the point cloud comprises a single-view point cloud.

17. The method of claim 14, wherein the surfaces comprise planar surfaces and curved surfaces.

18. The method of claim 14, wherein the edge map is generated by performing AND operation on the gradient map and the surface map.

19. The method of claim 14, wherein the step of inpainting the depth image is performed based on the edge map.

20. The method of claim 14, wherein step of inpainting the depth image uses exemplary-based algorithm.

21. The method of claim 14, wherein the step of inpainting the color image is performed based on the inpainted depth image.
